(19) United States
(12) Patent Application Publication
(10) Pub. No.: US 2024/0175416 A1
(43) Pub. Date: May 30, 2024

(54) FUEL INJECTOR FOR USE WITH LOW ENERGY DENSITY FUELS

(71) Applicants: The Regents of the University of Michigan, Ann Arbor, MI (US); PHILIP DINGLE CONSULTING, LLC., Rochester, MI (US)

(72) Inventors: André Louis Boehman, Ann Arbor, MI (US); Philip John Gregory Dingle, Rochester, MI (US)

(21) Appl. No.: 18/515,224

(22) Filed: Nov. 20, 2023

Related U.S. Application Data
(60) Provisional application No. 63/428,249, filed on Nov. 28, 2022.

(51) Int. Cl. F02M 61/18; F02M 61/10

(52) U.S. Cl. CPC F02M 61/1873; F02M 61/10

(57) ABSTRACT

A fuel injector includes a nozzle body, at least one injection orifice formed through an injection end of the nozzle body, and a tubular valve disposed in a bore of the nozzle body that moves between open and closed positions. Apertures formed through a wall of the tubular valve permit fuel to flow freely between opposite ends and along an inner surface of the valve, regardless of any limitations imposed by an annular gap between the valve and nozzle body. The injector provides exceptionally high fuel flow rates without increasing valve lift or injection orifice size over conventional diesel fuel injectors, making it ideal for synthetic fuels such as DME.

### TECHNICAL FIELD

The present disclosure relates generally to fuel injectors and, more particularly, to fuel injectors for use with low energy density fuels.

### BACKGROUND

Modern fuel injection systems for compression ignition engines have almost exclusively been designed, developed, and optimized for use with petroleum-based liquid fuels. The implication of this reality is that the dimensions and configurations chosen for the fuel injector, specifically the atomizing nozzle, have been optimized for the characteristics of those fuels. Such fuel injectors are not easily adapted for use with low carbon fuels, whose future use may be in higher demand to mitigate carbon emissions. Such fuels often have a low energy density relative to liquid petroleum-based fuels, making the required flow rate through a fuel injector higher for a given amount of engine power.

Dimethyl ether (DME), for example, requires a flow rate nearly twice as great as the flow rate of diesel fuel to deliver an equivalent amount of power from an engine. Relative to diesel fuel, DME and other synthetic alternatives also have a lower viscosity and lubricity. Conventional diesel injectors rely on fuel viscosity to dampen needle valve movement and thereby mitigate needle bounce during valve opening and closing events. They also rely on fuel lubricity to mitigate wear at injector valve seats. While synthetic diesel alternatives may be promising in terms of reduced carbon and hydrocarbon emissions and consistency in composition, these trade-offs present significant barriers to widespread adoption. Moreover, conventional techniques for addressing some of these problems only make the other problems worse.

For instance, one way to increase fuel flow through a fuel injector is to increase injection orifice size and to increase valve lift during a valve opening event to take advantage of the larger orifices. But this simple solution exacerbates needle bounce and valve seat wear—characteristics already compromised with diesel alternatives.

### SUMMARY

In accordance with various embodiments, a fuel injector includes a nozzle body, an injection orifice formed through the nozzle body, and a valve disposed in a bore of the nozzle body. The valve is moveable between a closed position, in which fuel in the bore is prevented from flowing through the injection orifice, and an open position, in which fuel in the bore is permitted to flow through the injection orifice. The valve is tubular such that fuel flows along an inner surface of the valve when the valve is in the open position.

In various embodiments, the valve includes a tubular wall that provides the inner surface of the valve and an outer surface of the valve. A gap is defined between the bore of the nozzle body and the outer surface of the valve, and the fuel injector further includes an aperture formed through the tubular wall such that the gap is in fluidic communication with an internal volume of the valve. The aperture may be formed through the tubular wall at one end of the valve, and the fuel injector may further include another aperture formed through the tubular wall at an opposite end of the valve.

In various embodiments, the inner surface extends the full length of the valve.

In various embodiments, the fuel injector includes a plug disposed in an end of the valve opposite an injection end of the valve. An internal volume of the valve is in fluidic communication with a control volume outside the valve via an opening formed through the plug.

In various embodiments, the valve rests along a valve seat of the nozzle body when the valve is in the closed position, and the valve seat includes separate first and second seating bands on axially opposite sides of the injection orifice.

In various embodiments, fuel flows to the injection orifice from axially opposite sides of the injection orifice when the valve is in the open position.

In various embodiments, the fuel injector has a valve-covering-orifice (VCO) construction and includes a sac formed in the nozzle body.

In various embodiments, a gap is defined between the bore and an outer surface of the tubular valve, and the valve further includes a guide section along an injection end of the valve. The gap is locally smaller at the guide section of the valve. The bore may have the same cross-sectional shape as the guide section such that the gap is uniform about the guide section. The valve may include a tubular wall that provides the inner surface of the valve and the outer surface of the valve, with a gap being defined between the bore of the nozzle body and the outer surface of the valve. The fuel injector may further include an aperture formed through the tubular wall and located axially between the guide section and the injection orifice. The fuel injector may further include another aperture formed through the tubular wall at an axially opposite side of the guide section. An inner diameter of the valve may be locally larger at the guide section.

In accordance with various embodiments, a fuel delivery system for a combustion engine includes a fuel injector having a nozzle body, an injection orifice formed through the nozzle body, and a valve disposed in a bore of the nozzle body. The valve is moveable between a closed position, in which fuel in the bore is prevented from flowing through the injection orifice, and an open position, in which fuel in the bore is permitted to flow through the injection orifice. The valve is tubular such that fuel flows along an inner surface of the valve when the valve is in the open position. The fuel delivery system includes a pressurized fuel source in fluidic communication with the bore of the nozzle body, and the pressurized fuel source includes a fuel having an energy density less than the energy density of diesel fuel.

In various embodiments, the fuel has an energy density less than 30 MJ/L, is a synthetic fuel having a chemical structure devoid of covalent carbon-carbon bonds, and/or is dimethyl ether.

In various embodiments, the pressurized fuel source operates at a fuel pressure less than 1000 bar.

It is contemplated that any one or more of the above-listed features, the features in the following description, and/or the features in the appended drawings can be combined in any technically feasible combination to define a claimed invention.

### DESCRIPTION OF DRAWINGS

FIG. 1 is cross-sectional view of a portion of an embodiment of a fuel injector;

FIG. 2 is an enlarged cross-sectional and cutaway view of an injection end of the fuel injector of FIG. 1 showing a valve of the injector in a closed position;

FIG. 3 is the cross-sectional and cutaway view of FIG. 1 showing the valve in an open position; and

FIG. 4 is a schematic depiction of a portion of an illustrative fuel delivery system for a combustion engine employing the fuel injector of FIGS. 1-3.

### DESCRIPTION OF EMBODIMENTS

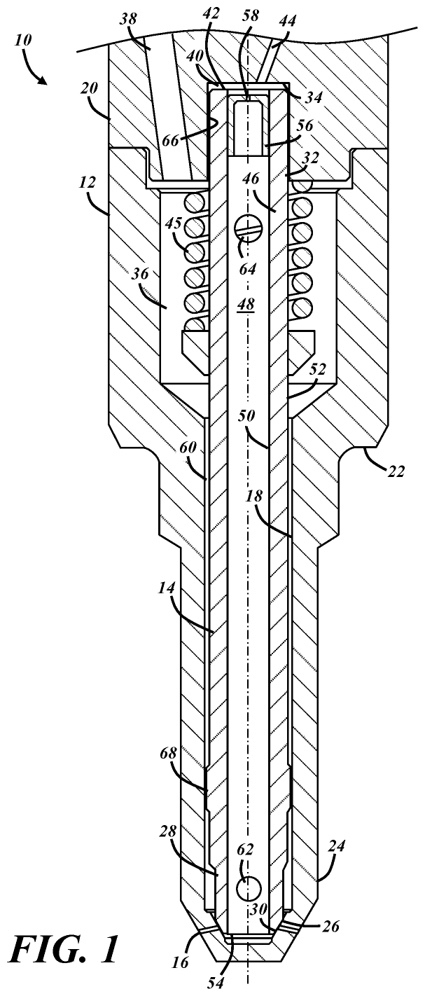

The fuel injector and fuel delivery system described below can deliver the high fuel flow rates required with low energy density fuels while mitigating valve bounce and valve wear. With reference to FIG. 1, an embodiment of a fuel injector 10 includes a nozzle body 12, a valve 14, and one or more injection orifices 16 formed through the nozzle body. The valve 14 is a needle valve disposed within a central bore 18 of the nozzle body 12 and housed between the nozzle body and a guide block 20. Though omitted here for simplicity in description, the fuel injector 10 may also include an injector housing and a cap nut between which the nozzle body 12 and guide block 20 are clamped. The injector housing may support a shoulder 22 of the nozzle body 12 against the clamp load of the cap nut, and an injection end 24 of the nozzle body may protrude from the injector housing.

The valve 14 is axially movable with respect to the nozzle body 12 between a closed position, in which fuel in the central bore 18 is prevented from flowing through the injection orifices 16, and an open position, in which fuel in the central bore is permitted to flow through the injection orifices. The valve 14 is illustrated in the closed position in FIG. 1, with a sealing surface 26 at an injection end 28 of the valve in contact with a valve seat 30 of the nozzle body 12. In the open position, the valve 14 is moved axially away from the valve seat 30 and, in a fully open position, an opposite end 32 of the valve is in contact with a stop surface 34 of the guide block.

An internal volume 36 of the nozzle body 12 is in fluidic communication with a high-pressure source of liquid fuel (e.g., a fuel rail) via a fuel inlet 38, which in this case is formed through the guide block 20. A control volume 40 at a proximal end 42 of the valve 14 is in fluidic communication with a control valve (not shown) via a control passage 44. When the control valve is closed and the control volume 40 and internal volume 36 of the nozzle body 12 are filled with fuel and pressurized by the fuel source, net forces from the fuel pressure press the valve 14 against the valve seat 30 due the larger projected area upon which the fuel pressure acts at the proximal end 42 of the valve than at the injection end 28 of the valve due to the differential area effect from the subtraction of the contact area of the sealing surface 26. A spring 45 may bias the valve 14 toward the closed position, ensuring a closed valve position even without fuel pressure. When the control valve opens (e.g., in response to a control module signal), the resulting pressure drop at the control volume 40 changes the net axial force on the valve 14 such that the valve is moved toward the open position, thereby permitting fuel to pass through the injection orifices 16 to be atomized and delivered to the working volume of a combustion engine for ignition.

The illustrated valve 14 is tubular and has a tubular wall 46 surrounding a hollow interior that defines an internal volume 48 of the valve. The wall 46 includes an inner surface 50 and an outer surface 52, each of which extends from the proximal end 42 of the valve 14 to a distal end 54 of the valve. The outer surface 52 includes the sealing surface 26 such that both the inner and outer surfaces 50, 52 extend the full axial length of the valve 14. The distal end 54 of the valve 14 is open by the full diameter of the inner surface 50. The proximal end 42 of the valve 14 is largely closed-off by a plug 56 disposed along the inner surface 50 of the wall 46. The plug 56 provides the necessary projected area to ensure the net axial force on the valve from the fuel pressure is toward the valve seat 30 when the control valve is closed but includes a small opening 58 to permit fuel to fill the control volume 40 when the valve 14 is in the closed position.

The valve 14 is configured so that fuel flows through its internal volume 48 and along its inner surface 50 when the valve is in the open position during an injection event. To facilitate fuel flow through the internal volume 48 of the valve 14, one or more apertures are formed through the tubular wall 46 to place the internal volume 48 in fluidic communication with a radial and annular gap 60 defined between the central bore 18 of the nozzle body 12 and the outer surface 52 of the valve 14. In the illustrated example, one such aperture 62 is formed through the wall 46 at the injection end 28 of the valve 14, and another aperture 64 is formed through the tubular wall at the opposite end 32 of the valve where the central bore 18 is at its maximum diameter. This arrangement permits the free flow of fuel from the fuel inlet 38 to the injection end 24 of the nozzle body regardless of any limitations imposed by the annular gap 60.

The illustrated valve 14 includes two guide sections, one of which is provided by the outer surface 52 at the end 32 of the valve in a central bore 66 of the guide block 20. Here, the end 32 of the valve 14 opposite the injection end has a close fit with the guide block bore 66 to help keep the valve centered within the central bore 18 of the nozzle body 12. The gap between the outer surface 52 and the guide block bore 66 is less than the nominal gap between the outer surface of the valve 14 and a central portion of the nozzle body bore 18.

A second guide section 68 is provided at the injection end 28 of the valve 14. The proximity of the second guide section 68 to the valve seat 30 helps the sealing surface 26 of the valve 14 seat properly on the valve seat 30 of the nozzle body 12 when moving to the closed position. The guide section 68 has a larger diameter than axially adjacent portions of the valve 14 such that the gap 60 between the outer surface 52 of the valve 14 and the bore 18 is locally reduced at the guide section. The additional restriction of the gap 60 at the guide section 68 is obviated by the hollow valve 14 permitting the free flow of fuel to the injection end 24 of the nozzle body 12. The guide section 68 can thus be made to have an exceptionally close fit with the central bore 18 of the nozzle body 12 because fuel entering the injector 10 can bypass the guide section through the internal volume of the valve 14.

As an added benefit, the gap 60 can also be made uniform around the entire guide section 68 due to the free flow of fuel through the interior of the valve. Otherwise, a flat or other flow feature would be required around the perimeter of the guide section 68 to permit axial fuel flow past the guide section, which increases valve complexity. The guide section 68 of the valve 14 can, for example, have the same shape (e.g., circular or cylindrical) as the nozzle body bore 18.

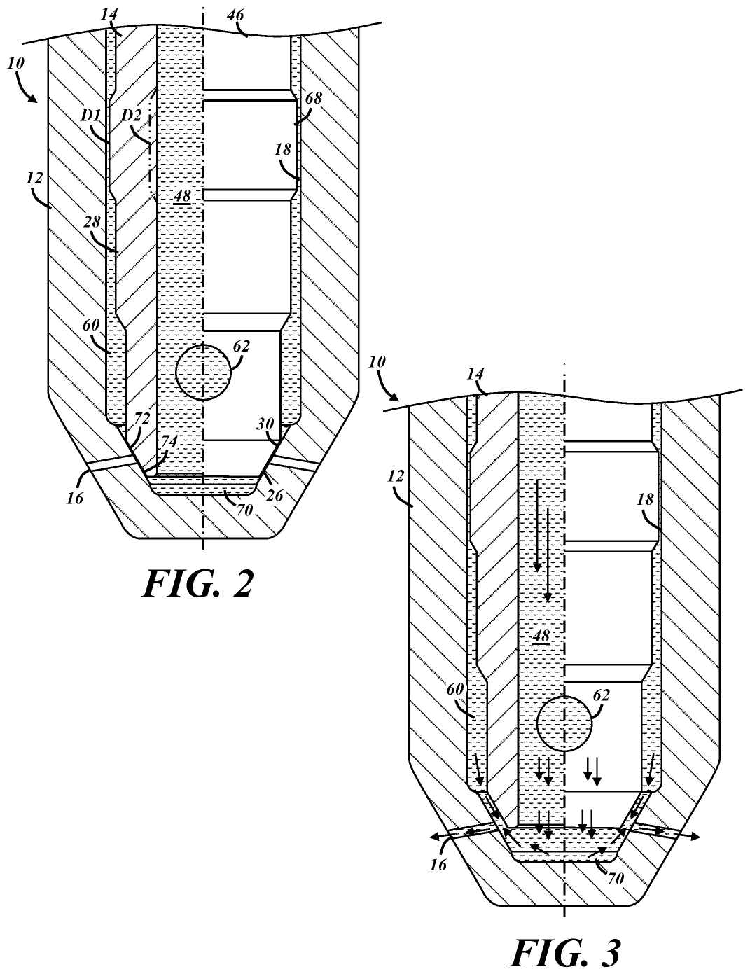

With reference to FIGS. 2 and 3, the illustrated fuel injector 10 has a valve-covering-orifice (VCO) construction, which is unconventional in modern fuel injectors for use in a compression ignition engine due to their tendency to produce relatively large amounts of particulates (i.e., soot) with typical hydrocarbon fuels. Modern diesel fuel injectors instead use a sac-type construction in which a small recess or “sac” is formed in the inner surface of the nozzle body at the extreme tip of the injection end of the nozzle body with the injection orifices leading out of the injector from the sac. The valve seat in a sac-type injector is axially spaced away from the orifices in a direction toward the supply end of the injector. Sac-type injectors produce less particulates due to favorable spray and atomization characteristics but have higher hydrocarbon (i.e., unburned fuel) emissions.

In a VCO construction as in FIG. 2, the sealing surface 26 of the valve 14 directly overlies the orifice 16 when seated on the valve seat 30 of the nozzle body 12. Where the injector is configured for use with so-called “smokeless” fuels such as DME or other synthetic low carbon liquid fuel, particulate production is not a problem, making the VCO construction advantageous with its much lower hydrocarbon emissions. In the example of FIGS. 2 and 3, the injector 10 also includes a sac 70, but with a different purpose than a conventional fuel injector sac. Due to the open end of the tubular valve 14 and the radially formed apertures 62, 64 in the tubular wall 46, the illustrated sac 70 is pressurized with fuel when the valve 14 is in the closed position as in FIG. 2.

In a conventional sac-type fuel injector, some residual fuel remains in the sac then the valve closes after an injection event. This residual fuel is vaporized by the heat of combustion when the injected fuel ignites in the engine cylinder and escapes the injector via the orifices as unburned hydrocarbon that leaves the engine with combustion exhaust gases during the engine exhaust stroke.

In the illustrated construction, the seated valve 14 prevents fuel in the sac 70 from exiting the injector via the orifices 16 until the valve is in the open position. As illustrated in FIG. 3, the sac 70 provides an additional fuel flow path to the orifices 16, with fuel flowing to each orifice from axially opposite sides of the orifices. In other words, some fuel flows from the gap 60 between the central bore 18 of the nozzle body 12 and the outer surface of the valve 14 to each orifice 16, and additional fuel flows from the sac 70 from the axially opposite side of each orifice. Moreover, fuel from the internal volume 48 of the valve 14 continuously provides unrestricted fuel flow to both the valve/bore gap 60 and to the sac 70 via the open end of the tubular valve and the aperture 62 during an injection event, thus negating any upstream flow restriction in the gap 60.

With reference to FIG. 2, the valve seat 30 thus includes two distinct seating bands on axially opposite sides of each orifice 16, with a first seating band 72 preventing fuel from flowing to each orifice 16 from the gap 60 and a second seating band 74 preventing fuel from flowing to each orifice from the sac 70 when the valve 14 is in the closed position. When the valve 14 is in the open position, some fuel reaches each orifice 16 flowing over the first seating band 72 and other fuel reaches each orifice flowing over the second seating band 74.

The hollow, tubular valve 14 may provide additional unexpected advantages. For instance, fuel pressure within the internal volume 48 of the valve 14 may help mitigate unwanted fluctuations in the size of the valve/bore gap 60. Conventional fuel injectors with solid needle valves are known to have problems with unwanted radially outward bulging or dilation along the length of the nozzle body 12 due to the relative high fuel pressure. This bulging effectively increases the size of the valve/bore gap, making a guide section 68 such as that of FIGS. 1-3 relatively ineffective. With the tubular valve 14 disclosed here, the valve may undergo a complimentary amount of bulge in the same radial direction to mitigate the unwanted change in gap size.

In a variation illustrated in phantom in FIG. 2, the inner surface 50 of the tubular valve 14 is profiled so that both the outer diameter D1 and the inner diameter D2 of the valve are locally increased at the guide section 68. This configuration makes the tubular wall 46 more flexible at the guide section 68 and may permit additional mitigation of valve/bore variation under high fuel pressures.

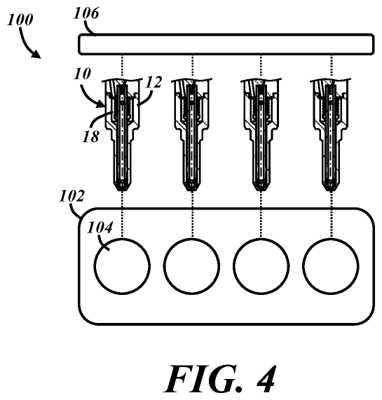

FIG. 4 schematically illustrates a portion of an illustrative fuel delivery system 100 for a combustion engine 102. The fuel delivery system 100 includes at least one fuel injector 10 as described above, with each injector configured to inject atomized fuel into an associated combustion chamber 104 of the engine 102 during a fuel intake stroke. The fuel delivery system 100 also includes a pressurized fuel source 106, such as a fuel rail, in fluidic communication with the bore 18 of each nozzle body.

The pressurized fuel source includes a liquid low energy density fuel. The fuel has an energy density that is less than diesel fuel and/or gasoline and may have an energy density less than 30 MJ/L, for example. In some embodiments, the fuel has an energy density in a range from 15 MJ/L to 25 MJ/L or from 18-23 MJ/L. In some embodiments, the fuel is a synthetic fuel. In some embodiments, the fuel has a chemical structure devoid of covalent carbon-carbon bonds. One suitable fuel is dimethyl ether. In some embodiments, the combustion engine 102 is compression-ignition engine—i.e., the engine does not rely on a high energy electrical arc for ignition of the fuel in the combustion chamber 104.

The above-described fuel injector represents a significant design overhaul in the art of compression-ignition fuel injection systems and uses some of the perceived disadvantages of diesel alternatives such as DME to its advantage while mitigating or eliminating other perceived disadvantages. For instance, in a conventional sac-type diesel fuel injector, the sac volume must be minimized to minimize hydrocarbon emissions. This limitation prevents simple enlargement of the valve seat diameter as a means of increasing fuel flow since such a modification would inherently increase hydrocarbon emissions by increasing sac volume. The above-described fuel injector is not so limited—i.e., the valve seat diameter can be enlarged to increase fuel flow without a corresponding increase in hydrocarbon emissions. Indeed, hydrocarbon emissions are effectively eliminated, even when the fuel delivery system uses a hydrocarbon fuel. Increased fuel flow via increased valve seat diameter decreases the need for additional valve lift, thereby decreasing valve momentum and impact energy at the valve seat during valve closure. The hollow valve, in addition to providing significantly freer fuel flow within the fuel injector, has a significantly lower mass than a comparable solid needle valve, which further decreases valve momentum and impact energy at the valve seat during valve closure-in mitigation of and in spite of the perceive disadvantage of the lower viscosity of diesel alternatives. The lower viscosity is instead turned to an advantage: the fuel delivery system does not have to operate at the extreme fuel rail pressures associated with diesel fuel. While conventional diesel fuel delivery systems often operate in excess of 2000 bar to mitigate smoke emissions, smokeless low carbon fuels such as DME can operate at fuel pressures of less than 1000 bar, or on the order of 500 bar.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A fuel injector, comprising:
a nozzle body;
an injection orifice formed through the nozzle body; and
a valve disposed in a bore of the nozzle body,
wherein the valve is moveable between a closed position, in which fuel in the bore is prevented from flowing through the injection orifice, and an open position, in which fuel in the bore is permitted to flow through the injection orifice,
the valve being tubular such that fuel flows along an inner surface of the valve when the valve is in the open position.

2. The fuel injector of claim 1, wherein the valve comprises a tubular wall that provides the inner surface of the valve and an outer surface of the valve, a gap being defined between the bore of the nozzle body and the outer surface of the valve, the fuel injector further comprising an aperture formed through the tubular wall such that the gap is in fluidic communication with an internal volume of the valve.

3. The fuel injector of claim 2, wherein the aperture is formed through the tubular wall at one end of the valve, the fuel injector further comprising another aperture formed through the tubular wall at an opposite end of the valve.

4. The fuel injector of claim 1, wherein the inner surface extends the full length of the valve.

5. The fuel injector of claim 1, further comprising a plug disposed in an end of the valve opposite an injection end of the valve, wherein an internal volume of the valve is in fluidic communication with a control volume outside the valve via an opening formed through the plug.

6. The fuel injector of claim 1, wherein the valve rests along a valve seat of the nozzle body when the valve is in the closed position, the valve seat comprising separate first and second seating bands on axially opposite sides of the injection orifice.

7. The fuel injector of claim 1, wherein fuel flows to the injection orifice from axially opposite sides of the injection orifice when the valve is in the open position.

8. The fuel injector of claim 1, wherein the fuel injector has a valve-covering-orifice (VCO) construction and comprises a sac formed in the nozzle body.

9. The fuel injector of claim 1, wherein a gap is defined between the bore and an outer surface of the tubular valve, the valve further comprising a guide section along an injection end of the valve, wherein the gap is locally smaller at the guide section of the valve.

10. The fuel injector of claim 9, wherein the bore has the same cross-sectional shape as the guide section such that the gap is uniform about the guide section.

11. The fuel injector of claim 9, wherein the valve comprises a tubular wall that provides the inner surface of the valve and the outer surface of the valve, a gap being defined between the bore of the nozzle body and the outer surface of the valve, the fuel injector further comprising an aperture formed through the tubular wall, the aperture being located axially between the guide section and the injection orifice.

12. The fuel injector of claim 11, further comprising another aperture formed through the tubular wall at an axially opposite side of the guide section.

13. The fuel injector of claim 9, wherein an inner diameter of the valve is locally larger at the guide section.

14. A fuel delivery system for a combustion engine, the fuel delivery system comprising the fuel injector of claim 1 and a pressurized fuel source in fluidic communication with the bore of the nozzle body, the pressurized fuel source comprising a fuel having an energy density less than the energy density of diesel fuel.

15. The fuel delivery system of claim 14, wherein the fuel has an energy density less than 30 MJ/L.

16. The fuel delivery system of claim 14, wherein the fuel is a synthetic fuel having a chemical structure devoid of covalent carbon-carbon bonds.

17. The fuel delivery system of claim 14, wherein the fuel is dimethyl ether.

18. The fuel delivery system of claim 14, wherein the pressurized fuel source operates at a fuel pressure less than 1000 bar.
